(19) United States
(12) Patent Application Publication
(10) Pub. No.: US 2024/0232411 A9
(43) Pub. Date: Jul. 11, 2024

(54) DATA MANAGEMENT SYSTEM, DATA MANAGEMENT SERVER, DATA MANAGEMENT METHOD, DATA MANAGEMENT PROGRAM, AND RECORDING MEDIUM

(71) Applicant: FANUC CORPORATION, Minamitsuru-gun, Yamanashi (JP)

(72) Inventor: Hiroki HOKAZONO, Yamanashi (JP)

(21) Appl. No.: 18/277,899

(22) PCT Filed: Mar. 7, 2022
(86) PCT No.: PCT/JP2022/009662

§ 371 Date: Aug. 18, 2023

(30) Foreign Application Priority Data
Mar. 12, 2021 (JP) 2021-040743

(51) Int. Cl. G06F 21/62

(52) U.S. Cl. CPC G06F 21/6218

(57) ABSTRACT

A receiving side server as a data management server is provided with: a reacquisition condition management unit that records and manages reacquisition condition information in which information related to a data file stored in a database is associated with reacquisition available/unavailable information related to the possibility of acquisition of the data file; a data transmission unit that registers a reacquisition condition information of a data file in the reacquisition condition management unit on the basis of reacquisition available/unavailable information attached to a data file provided externally, and transmits the provided data file to the database; and a data acquisition unit that, upon reception of an acquisition request for the data file stored in the database, acquires the data file from the database only if acquisition of the data file is permitted on the basis of the reacquisition condition information managed by the reacquisition condition management unit.

### TECHNICAL FIELD

The present invention relates to a data management system, a data management server, a data management method, a data management program, and a recording medium.

### BACKGROUND ART

In the field of manufacturing equipment, in recent years, server application software (hereinafter, simply referred to as “applications” or “apps”) such as “visualization”, “quality improvement”, “maintenance” and “developer tool software/converter” having various functions and purposes for manufacturing sites has been developed in various companies.

For example, when a developer such as a system integrator develops an application for a manufacturing site based on the processing data accompanying the operation of edge devices such as machine tools, industrial device, and industrial robots in the manufacturing site, the developer needs to obtain the processing data accompanying the operation of the edge devices necessary for the application, transmit the processing data to a database in the developer's development environment, and perform the application development work (for example, refer to Patent Document 1).

More specifically, the processing data of the edge device includes, for example, data indicating an action state of the edge device, data indicating a production state, data indicating a quality state of a product, data indicating an event (history) such as an operation state, and the like. These pieces of processing data are data-modeled (i.e., standardized) in advance, and by storing these standardized processing data (hereinafter also referred to as “virtual device data”) in a predetermined database corresponding to the standardized data model, the application can access the processing data via a predetermined API (hereinafter also referred to as “access API”). The processing data of the edge device provided from the manufacturing site is stored in a form corresponding to a data model standardized in a database in the development environment.

An example of a form for providing the processing data accompanying the operation of the edge device, which is provided from a providing-side server to a receiving-side server, is shown. Here, the providing-side server is installed in the manufacturing site environment, and the receiving-side server is installed in the development environment.

The processing data stored in the database included in the providing-side server and accompanying the operation of the edge device is outputted as virtual device data by a database operation tool, encrypted, and exported to the outside. The encrypted virtual device data is provided to a receiving-side server, which imports and decrypts the encrypted virtual device data, and then stores the encrypted virtual device data in a database included in the receiving-side server by the database operation tool.

With such a configuration, the developer can access the processing data via the access API to perform the application development work.
Patent Document 1: Japanese Unexamined Patent Application, Publication No. 2020-021214

### DISCLOSURE OF THE INVENTION

### Problems to be Solved by the Invention

Here, even if the provider of the processing data accompanying the operation of the edge device encrypts the processing data and provides the encrypted processing data to the developer of the application, the processing data is stored in the database in a decrypted state when the processing data is stored in the database in the development environment. This makes it possible for all of the users who can log into the development environment (all the developers including the providing destinations of the data) to obtain the processing data in a decrypted state from the database via the database operation tool and, therefore, it is likely to cause a risk in that the data of the providing side is secondarily used by any developer and another potential risk. Then, for example, by analyzing the machine information, it is possible to grasp how much manufacturing capability each machine has. Furthermore, it is possible to grasp how many products are manufactured by the factory by recognizing the manufacturing capability of each machine. Moreover, there is a risk in that the sales of the company operating the factory can be grasped by recognizing the manufacturing capability of the factory.

For this reason, even if the data is stored in the database of the providing destination when the data is provided to the outside, a function is required which enables the data provider to control so that any user is not able to acquire (download) the data at the providing destination, whereby any user is not able to acquire (download) the data via the database operation tool at the providing destination.

It is an object for the present invention to provide a data management system, a data management server, a data management method, a data management program, and a recording medium capable of securely preventing provided data from leaking to the outside by a data provider designating in advance that, when the data is provided to the outside, not any user can acquire (download) the data via a database operation tool at the providing destination, even if the data is stored in a database of the providing destination.

### Means for Solving the Problems

(1) An aspect of a data management server according to the present invention is directed to a data management server including: a control unit; a database; a reacquisition condition management unit configured to record and manage reacquisition condition information in which information relating to a data file stored in the database and reacquisition available/unavailable information relating to whether the data file is available or unavailable for acquisition are associated with each other; a data transmission unit configured to, based on the reacquisition available/unavailable information added to a data file to be provided from outside of the data management server, register the reacquisition condition information of the data file in the reacquisition condition management unit and transmit the data file to the database; and a data acquisition unit configured to, when receiving a request for acquiring the data file stored in the database, based on the reacquisition condition information managed by the reacquisition condition management unit, acquire the data file from the database only when acquisition of the data file is permitted.

(2) An aspect of a data management method according to the present invention is directed to a data management method for storing a data file provided from outside in an internal database, the method executed by a computer including a control unit and a database, the method including the steps of: recording and managing reacquisition condition information in which information relating to a data file stored in the database and reacquisition available/unavailable information relating to whether the data file is available or unavailable for acquisition are associated with each other; based on the reacquisition available/unavailable information added to a data file to be provided from outside of the data management server, registering the reacquisition condition information of the data file and transmitting the data file to the database; and when receiving a request for acquiring the data file stored in the database, based on the managed reacquisition condition information, acquiring the data file from the database only when acquisition of the data file is permitted.

(3) An aspect of a data program according to the present invention is directed to a data management program for storing a data file provided from outside in an internal database, the program executed by a computer including a control unit and a database, the program including the steps of: recording and managing reacquisition condition information in which information relating to a data file stored in the database and reacquisition available/unavailable information relating to whether the data file is available or unavailable for acquisition are associated with each other; based on the reacquisition available/unavailable information added to a data file to be provided from outside of the data management server, registering the reacquisition condition information of the data file and transmitting the data file to the database; and when receiving a request for acquiring the data file stored in the database, based on the managed reacquisition condition information, acquiring the data file from the database only when acquisition of the data file is permitted.

(4) An aspect of a data management system according to the present invention is directed to a data management system including: a receiving-side server serving as a data management server according to (1); and a providing-side server that creates a data file provided from outside to the receiving-side server, the providing-side server including a control unit, and a database, the control unit including a data acquisition unit configured to acquire a data file stored in the database, a reacquisition condition creation unit configured to add to the data file reacquisition available/unavailable information in which whether the data file is available or unavailable for acquisition is designated, and a data output unit configured to output the data file to which the reacquisition available/unavailable information is added by the reacquisition condition creation unit to outside as a provision data file to be provided to the receiving-side server.

### Effects of the Invention

According to the present invention, it is possible to provide a data management system, a data management server, a data management method, a data management program, and a recording medium capable of securely preventing provided data from leaking to the outside by a data provider designating in advance that, when the data is provided to the outside, not any user can acquire (download) the data via a database operation tool at the providing destination, even if the data is stored in a database of the providing destination.

### BRIEF DESCRIPTION OF THE DRAWINGS

FIG. 1 is a schematic diagram showing a basic configuration of a data management system according to one embodiment of the present invention;

FIG. 2 is a functional block diagram of a providing-side server according to the present embodiment;

FIG. 3 is a schematic diagram of a providing-side application program executed by a providing-side server according to the present embodiment;

FIG. 4 is a functional block diagram of a receiving-side server as a data management server according to the present embodiment;

FIG. 5 is a schematic diagram of a receiving-side application program executed by the receiving-side server according to the present embodiment;

FIG. 6 is a diagram showing an example of data use condition information according to the present embodiment;

FIG. 7 is a flowchart showing processing for creating data to be provided to the outside from the database of the providing-side server according to the present embodiment;

FIG. 8 is a flowchart showing processing until the receiving-side server receives a data file from the outside and stores the data file in the database;

FIG. 9 is a flowchart showing processing of acquiring data in the receiving-side server according to the present embodiment; and

FIG. 10 is a schematic diagram showing an example of a mode in which provision data from the providing-side server via the cloud is provided to the receiving-side server according to the present embodiment.

### PREFERRED MODE FOR CARRYING OUT THE INVENTION

An example of the configuration of the data management system 1000 according to the present embodiment will be described. Here, as data, processing data accompanying the operation of edge devices such as machine tools, industrial device, and industrial robots in the manufacturing site is exemplified. Furthermore, as an example of an external server that creates and provides data, a server (also referred to as a “providing-side server”) that accesses processing data of manufacturing equipment (edge device) including a CNC machine tool, industrial device, industrial robot, and the like installed in a manufacturing site such as a factory and performs predetermined information processing relating to the application is exemplified. Furthermore, as a server (also referred to as a “receiving-side server”) of the present invention, for example, a server installed in a development environment, in which a developer develops an application based on data provided from the providing-side server, is exemplified. However, the data, the server, and the like of the present invention are not limited thereto. The present invention can be applied to any data and any server.

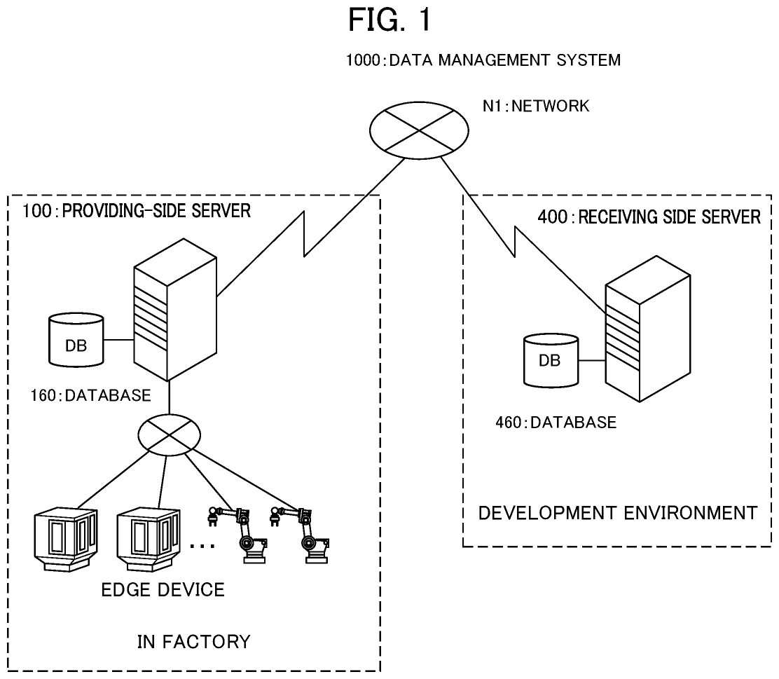

FIG. 1 is a schematic diagram showing the basic configuration of the data management system 1000 according to the present embodiment. As shown in FIG. 1, the data management system 1000 includes a providing-side server 100 and a receiving-side server 400 serving as a data management server. It should be noted that the providing-side server 100 and the receiving-side server 400 may be connected via the network N1. Examples of the network include the Internet, a VPN (Virtual Private Network), and a public telephone network. There are no particular restrictions on a specific communication method in the network, and whether the network is wired or wireless.

In the present embodiment, the providing-side server 100 is, for example, a server that executes an application to access processing data of manufacturing equipment (edge device) including a CNC machine tool, industrial device, industrial robot, and the like installed in a manufacturing site such as a factory to perform predetermined information processing relating to the application. Here, the processing data indicates virtual device data such as data indicating an action state of the edge device, data indicating a production state, data indicating a quality state of a product, and data indicating an operation state. The data provider extracts, for example, processing data (virtual device data) of the edge device from the database 160 of the providing-side server 100, and provides the extracted processing data to the developer. With such a configuration, the developer can store the processing data (virtual device data) in the database 460 (e.g., debugging database) of the receiving-side server 400 as a development environment, and can perform the application development work using the processing data (virtual device data).

The receiving-side server 400 can execute any application. At this time, among the virtual device data provided from the providing-side server 100 and stored in the database 460, the data set by the data provider as unavailable for acquisition is configured such that, even when the data is stored in the database if the providing destination, not any user can acquire (download) the data via the database operation tool at the providing destination.

Next, functions of each device of the data management system 1000 will be described.

### <Providing Side Server 100>

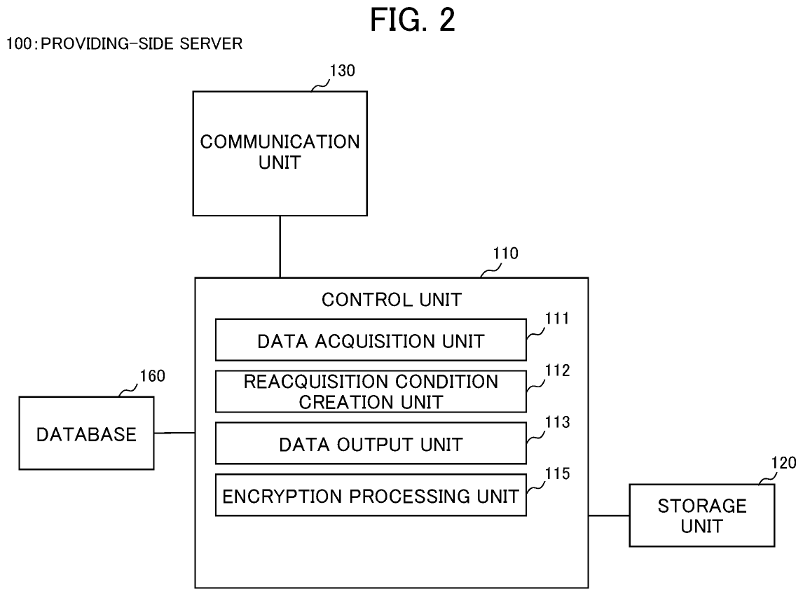

FIG. 2 is a functional block diagram showing functions of the providing-side server 100. As shown in FIG. 2, the providing-side server 100 includes a control unit 110, a storage unit 120, a communication unit 130, and a database 160. The database 160 is built in an internal or external storage device managed by the providing-side server 100.

Before describing the control unit 110, the storage unit 120, the communication unit 130, and the database 160 will be briefly described.

The storage unit 120 stores programs executed by the control unit 110, and has a storage area (referred to as a “data storage unit”) for temporarily storing data acquired from the database 160 by the data acquisition unit 111, as will be described later.

The communication unit 130 is a communication control device that transmits and receives data to and from an external device (for example, an edge device, a client terminal, a receiving-side server 400, and the like) via a network.

In the present embodiment, as described above, the database 160 stores, for example, data (virtual device data) generated based on a standardized data model of processing data of the edge devices.

Specifically, in the database 160 exemplified in the present embodiment, a data structure for storing virtual device data generated based on a standardized data model is prepared in advance. One element of such a data structure is referred to as an instance, and an identifier thereof is referred to as an instance ID. Each piece of data stored in the instance is also referred to as a moment. Specifically, data in one time stamp is referred to as a moment.

Furthermore, the database 160 illustrated in the present embodiment is configured to be stored in an instance identified by an instance ID by designating the instance ID and transmitting the data (specifically, POST transmission) in order to store one virtual device data in the instance. Thus, by transmitting data using the instance ID as a transmission destination, the data is recorded in the instance. The database 160 illustrated in this embodiment may include the database operation tool and the access API described later. However, the present invention is not limited to virtual device data and a database system that stores virtual device data. The present invention can be applied to any data and any database system that stores the data. Specifically, since the terms “instance”, “moment”, “data transmission unit” and “transmit data to database” in the database 160 exemplified in the present embodiment correspond to “data files such as tables”, “one record data”, “data registration unit” and “storing data in database” in a normal database, respectively, the present invention can be read as described above. Therefore, the present invention can be applied to any data and any database storing the data.

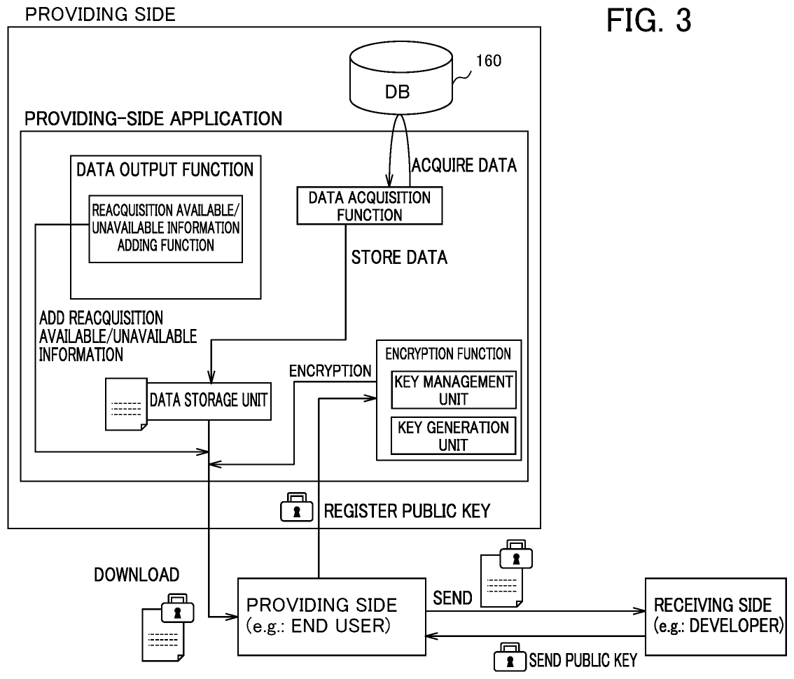

The control unit 110 is, for example, a CPU, and controls the providing-side server 100 by executing various programs stored in the storage unit 120. FIG. 3 is a schematic diagram of a providing-side application program (also referred to as a “provision data creation program”) executed by the providing-side server 100. Hereinafter, the “application” may also be referred to as an “app”.

For example, the control unit 110 executes a program for obtaining virtual device data to be provided to the receiving-side server 400 from the database 160 (hereinafter, also referred to as “data obtaining processing”), and temporarily stores the obtained virtual device data in the storage unit 120. The control unit 110 executes a program for adding reacquisition available/unavailable information (“reacquisition available/unavailable information adding function”) that the provision data stored in the receiving-side server 400 is available or unavailable for acquisition (that is, whether it is permitted or not permitted for any user (including a user at a providing destination) in the receiving-side server 400 to acquire the provision data), and outputting (hereinafter referred to as “exporting”) the data to the outside for data output (hereinafter, referred to as “data output processing”). It should be noted that the program (in particular, a program for data acquisition and a program for data output) for the provision data creation processing may be a program included in management software (hereinafter also referred to as “database operation tool”) prepared in the database 160.

As shown in FIG. 2, by executing the provision data creation program, the control unit 110 includes a data acquisition unit 111, a reacquisition condition creation unit 112, a data output unit 113, and an encryption processing unit 115 as functional configurations.

First, the data acquisition unit 111 will be described.

The data acquisition unit 111 acquires provision data from the database 160 in response to a data acquisition instruction inputted from a user (for example, a data provider) via, for example, a terminal (not shown) communicably connected to the providing-side server 100. The acquired data may be stored in the data storage unit of the storage unit 120. Here, the instruction information included in the data acquisition instruction may include a data file name (for example, an instance ID) and a target range (for example, the identification information of the first data and the identification information of the last data as a provision target range) of data to be provided among data included in the data file. Furthermore, the number of data to be acquired may be designated. When the provision target range is not designated, the data acquisition unit 111 may acquire all the data included in the data file, and may create the first identification information and the last identification information of the data included in the data file as defaults. When the provision data is virtual device data, a time stamp assigned to each data may be applied as identification information designating the target range.

The data acquisition instruction may include the reacquisition available/unavailable information designating whether it is available or unavailable for a developer at the providing destination of the data (i.e., the receiving-side server 400) to acquire the data. Thus, a user (e.g., a data provider) can input information necessary for providing data at the same time, so that input efficiency can be improved. In this case, the data acquisition unit 111 may provide the reacquisition available/unavailable information to the reacquisition condition creation unit 112, which will be described later.

In addition, the reacquisition available/unavailable information may include a predetermined data target range (for example, a predetermined time stamp range in a case of virtual device data) that permits or does not permit acquisition together with acquisition possibility, as well as the information in relation to whether it is available/unavailable for acquisition. It should be noted that, when the acquisition of data to be provided to the receiving-side server 400 is permitted, the reacquisition available/unavailable information may be null (hereinafter also referred to as “empty”).

Furthermore, among the data provided to the receiving-side server 400, a target range of the data may be divided into several partial ranges, and whether it is available or unavailable for acquisition may be designated for each partial range.

Basically, it is preferable to provide the data to the receiving-side server in a state where the reacquisition available/unavailable information is always added. In this case, whether the acquisition is OK or NG (not acceptable) is always added as the reacquisition available/unavailable information. However, the reacquisition available/unavailable information is not added to the data created and provided by components other than the providing-side server 100 described in the present embodiment. Therefore, in such a case, the data can be acquired as a default.

Next, the reacquisition condition creation unit 112 will be described. The reacquisition condition creation unit 112 adds the reacquisition available/unavailable information designating whether the data of the target range is available or unavailable, the information corresponding to, for example, the provision target range of the data file extracted from the database by the data acquisition unit 111 and stored in the data storage unit of the storage unit 120. The reacquisition condition creation unit 112 may be included in a data output unit 113 described later. The user can input the data to the reacquisition condition creation unit 112 via a client terminal or the like (not shown) corresponding to the provision target range of the data file stored in the data storage unit.

When the reacquisition available/unavailable information is not designated, the reacquisition condition creation unit 112 creates the reacquisition available/unavailable information as empty (null) indicating permission to acquire the reacquisition available/unavailable information. With such a configuration, the data provided from the providing-side server 100 to the outside is added with the reacquisition permission information including the empty (null) information.

Finally, the data output unit 113 will be described. The data output unit 113 outputs the data file to which the reacquisition available/unavailable information is added by the reacquisition condition creation unit 112 to the outside as a data file (hereinafter also referred to as a “provision data file”) to be provided to the receiving-side server 400.

The data output unit 113 may encrypt the provision data file using key data of a public key system or a common key of a common key system in order to ensure security of data when outputting the data to the outside.

Specifically, the control unit 110 may include an encryption processing unit 115. In this case, for example, the public key of the receiving side is notified in advance to the providing side, so that the encryption processing unit 115 may encrypt by applying the public key. Furthermore, the encryption processing unit 115 may generate a common key, encrypt the generated common key by applying a public key to the generated common key, and generate an encrypted common key and provision data encrypted by applying the common key.

The provision data file outputted to the outside by the data output unit 113 may be transmitted to the receiving-side server 400 via the communication unit 130. Alternatively, the provision data file may be stored in a storage medium, and may be mailed or handed over. As described later, the providing-side server 100 may upload the provision data file to the cloud, and the receiving-side server 400 may download the provision data file from the cloud.

The functions of the providing-side server 100 have been described above. Next, functions of the receiving-side server 400 will be described.

### <Receiving Side Server>

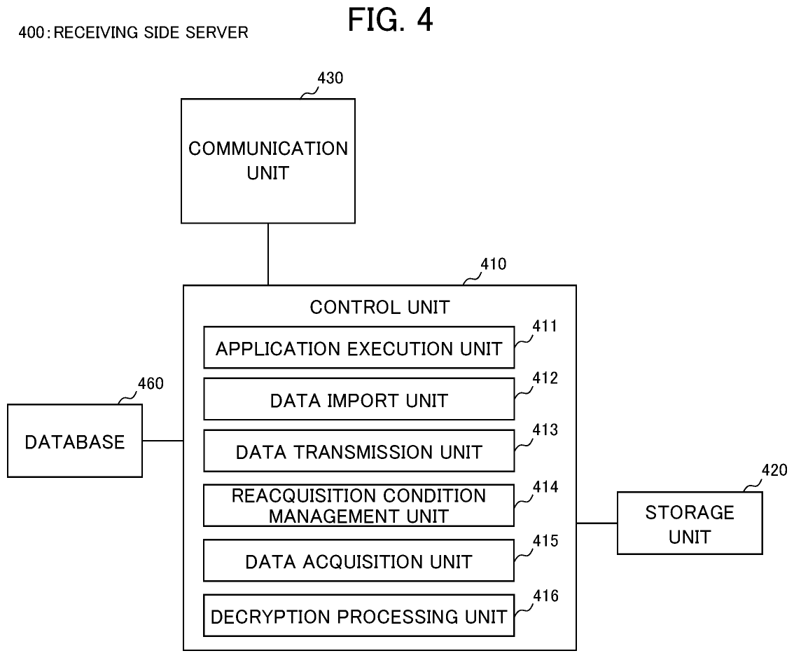

FIG. 4 is a functional block diagram showing functions of the receiving-side server 400. As shown in FIG. 4, the receiving-side server 400 includes a control unit 410, a storage unit 420, a communication unit 430, and a database 460. The database 460 is built in an internal or external storage device managed by the receiving-side server 400. The storage unit 420 and the communication unit 430 are equivalent to those of the providing-side server 100, and a description thereof will be omitted. The receiving-side server 400 may be implemented as a virtual server on the cloud known to those skilled in the art.

The database 460 may have the same function as the database 160 of the providing-side server 100. Therefore, as described above, the database operation tool and the access API related to the database 460 may be prepared in advance in the receiving-side server 400. Furthermore, in order to store the virtual device data in a predetermined instance of the database 460, the instance ID is designated and the data is transmitted to be stored in the instance that identifies the instance ID. Thus, by transmitting data using the instance ID as a transmission destination, the data is recorded in the instance.

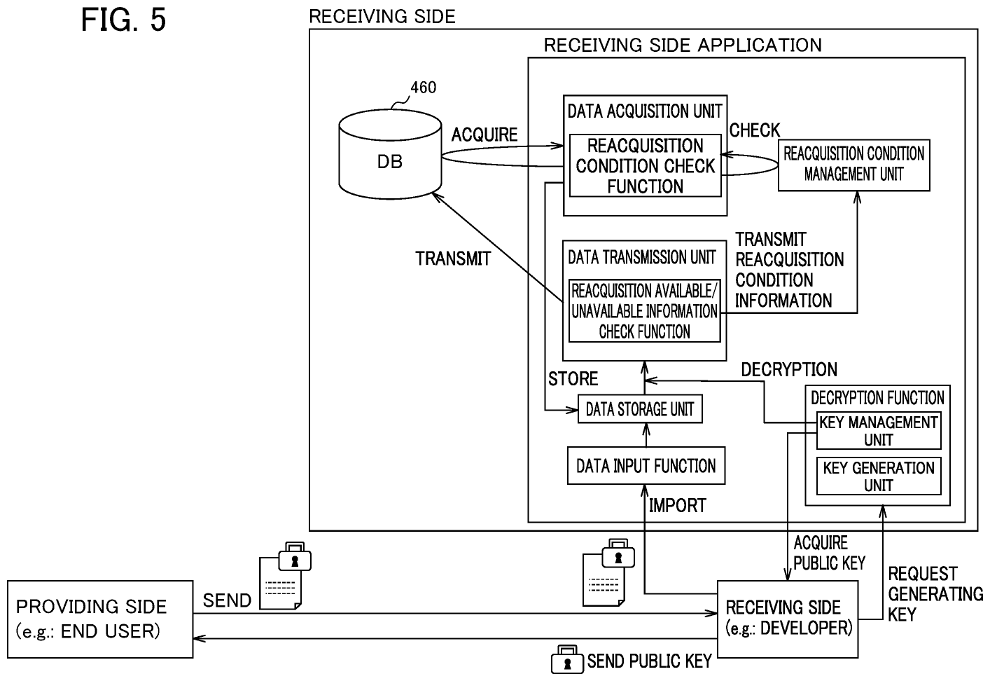

The control unit 410 is, for example, a CPU, and performs overall control of the receiving-side server 400 by executing various programs stored in the storage unit 420. FIG. 5 is a schematic diagram of a receiving-side application program executed by the receiving-side server 400. Hereinafter, the “application” may also be referred to as an “app”.

For example, the control unit 410 executes a program for executing an application for executing a receiving-side application stored in the storage unit 420 (hereinafter referred to as “application execution processing”).

Furthermore, the control unit 410 executes a program for performing reacquisition condition management (hereinafter referred to as “reacquisition condition management processing”) for recording and managing (registering) the reacquisition condition information in which information relating to a data file stored in the database 460 and the reacquisition available/unavailable information relating to whether or not the data file can be acquired are associated with each other.

Furthermore, when the control unit 410 receives an acquisition request for data stored in the database 460 from any user (including a user at a providing destination) in the receiving-side server 400, the control unit 410 executes, based on a comparison between the requested data for acquisition and the reacquisition condition information, a program of data acquisition (hereinafter referred to as “data acquisition processing”) for checking whether or not the acquisition of the data is designated as unavailable, and acquiring the data from the database 460 when the acquisition is permitted.

Furthermore, the control unit 410 imports the provision data files provided from the providing-side server 100, temporarily stores them in the storage unit 420, and when the imported provision data files are encrypted, the control unit 410 decrypts them and executes a program for performing data input (hereinafter referred to as “data input processing” or “import processing”) for providing the decrypted provision data files to data transmission processing described later.

Furthermore, the control unit 410 executes, based on the reacquisition available/unavailable information added to a data file provided from the outside and in which whether the data file is available or unavailable for acquisition is designated, a program of data transmission (hereinafter referred to as “data transmission processing”) for registering the reacquisition condition information in which information relating to the data file and the reacquisition available/unavailable information of the data file are associated with each other, and designating the instance ID and transmitting the data for storing the provided data file in the database 460. As described above, in order to store the data in the instance, the database 460 illustrated in the present embodiment designates the instance ID to transmit the data (specifically, POST transmission) such that the data is stored in the instance identified by the instance ID. That is, in the present embodiment, “data transmission by designating an instance ID and transmitting the data” is synonymous with recording or storing the data in the instance.

It should be noted that the program for reacquisition condition information management processing and the program for data transmission processing may be software included in management software (database operation tool) prepared in advance in the data management system.

As described above, by executing a program for application execution processing, a program for import processing, a program for data transmission processing, a program for reacquisition condition information management processing, and a program for data acquisition processing, as shown in FIG. 4, an application execution unit 411, a data import unit 412, a data transmission unit 413, a reacquisition condition management unit 414, and a data acquisition unit 415 are provided in the control unit 410 as functional configurations.

The application execution unit 411 executes an application stored in an application storage unit (not shown) of the storage unit 420 on the receiving-side server 400 in response to a start-up request from, for example, a user or any operating system.

The data import unit 412 imports the provision data file provided from the providing-side server 100 into the receiving-side server 400. Specifically, the provision data file may be stored in the data storage unit of the storage unit 420.

In order to secure the security of data, when the provision data file is encrypted using the key data of the public key method or the common key of the common key method as described above, it is necessary to decrypt the encrypted provision data file.

Therefore, the control unit 410 may be provided with a decryption processing unit 416. Specifically, for example, when the provision data file is encrypted by applying the public key of the receiving side, the decryption processing unit 416 can decrypt by applying the private key of the receiving side. Furthermore, when the provision data file is encrypted by applying the common key generated on the providing side, the decryption processing unit 416 can decrypt the encrypted common key by applying the public key and the private key on the receiving side, and can decrypt the encrypted provision data by applying the decrypted common key. With such a configuration, the data import unit 412 can output the provision data decrypted by the decryption processing unit 416 to the data transmission unit 413.

Before describing the data transmission unit 413, the reacquisition condition management unit 414 will be described.

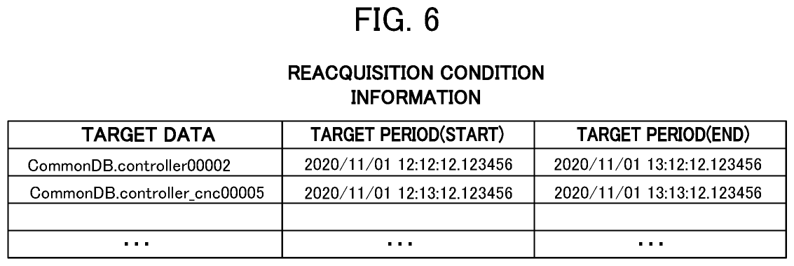

As will be described later, the data transmission unit 413 records and manages information relating to a data file to be transmitted to the database 460 in the reacquisition condition management unit 414. Here, the information related to the data file includes reacquisition condition information in which, for example, among the instance IDs as data file names and the data transmitted to the instances, a range from the first time stamp to the last time stamp in the time series data as identification information of the first data and identification information of the last data indicating the target range of the data indicating unavailable for acquisition are associated. FIG. 6 shows an example of the reacquisition condition information. Furthermore, when the reacquisition condition management unit 414 adds the information indicating that it is unavailable for acquisition to only the data of the partial range included in the provision data file, and does not add the information indicating that it is unavailable for acquisition to the remaining range, the reacquisition condition management unit 414 records and manages the reacquisition condition information that sets the partial range as the target range of the data indicating that it is unavailable for acquisition. Null (empty) is associated with the remaining range (available range).

In addition, as described above, when null (empty) is added as the reacquisition available/unavailable information, all of the data files may be registered as available.

Specifically, in the reacquisition condition management unit 414, when the newly inputted reacquisition condition information is the same data file name (the same instance ID) as the reacquisition condition information already recorded and managed by the reacquisition condition management unit 414, the data transmission unit 413 records and manages (updates) the newly inputted reacquisition condition information such that the reacquisition condition information that is already recorded and managed by the reacquisition condition management unit 414 is overwritten with the newly inputted reacquisition condition information. Thus, for example, when the target range of data indicating that it is unavailable for acquisition in the newly inputted reacquisition condition information is empty (null) (i.e., when acquisition is permitted), if the same data file name (the same instance ID) is used, the data file name (the instance ID) included in the reacquisition condition information that has already been recorded and managed is the same, and the target range of data indicating that it is unavailable for acquisition partially overlaps, the data in the overlapping range is updated to indicate that it is available for acquisition.

The reacquisition condition management unit 414 can update the reacquisition condition information managed by the reacquisition condition management unit 414 periodically or in response to a request from the user to establish as the latest state. Specifically, the reacquisition condition management unit 414 may compare the reacquisition condition information with the data recorded in the database 460 periodically or in response to a request from the user, and when data corresponding to the reacquisition condition information is not present in the database 460, the reacquisition condition management unit 414 may delete the reacquisition condition information. When the range of data actually included in the data file corresponding to the reacquisition condition information is smaller than the target range managed in the reacquisition condition, the target range managed in the reacquisition condition may be reduced to the range of data included in the data file.

Next, the data transmission unit 413 will be described.

The data transmission unit 413 creates reacquisition condition information in which information relating to the data file based on the reacquisition available/unavailable information added to the data file provided from the data import unit 412, and reacquisition available/unavailable information of the data file are associated with each other, and registers the reacquisition condition information in the reacquisition condition management unit 414. In addition, as described above, when null (empty) is added as the reacquisition available/unavailable information, all of the data files may be registered as available.

In addition, as described above, when the information in which the data in the partial range included in the provision data file is unavailable for acquisition is added and the remaining range is empty (null), the data transmission unit 413 may create the reacquisition condition information in which data in the partial range is set as a target range of the data indicating that it is unavailable for acquisition, and register the information in the reacquisition condition management unit 414.

The processing contents of the data transmission unit 413 updating the reacquisition condition information registered in the reacquisition condition management unit 414 based on the newly created reacquisition condition information have been described in the reacquisition condition management unit 414, and thus a description thereof is omitted.

The data transmission unit 413 registers the reacquisition condition information of the data file provided from the outside in the reacquisition condition management unit 414, and then transmits the data file to the database 460. In this way, since an acquisition request for a data file (instance) stored in the database 460 is requested to the database 460 via the data acquisition unit 415 described later, it is not possible for the developer to easily acquire data of the data file. Therefore, it is possible for the data provider to prevent unintended developers from acquiring the data.

Finally, the data acquisition unit 415 will be described.

When the data acquisition unit 415 receives the request to acquire the data file stored in the database 460, the data acquisition unit 415 acquires the data file from the database 460 only when the acquisition of the data file is permitted based on the reacquisition condition information managed by the reacquisition condition management unit 414.

Specifically, when receiving a request to acquire a data file (instance) stored in the database 460 from any user (including a user at a providing destination) in the receiving-side server 400, the data acquisition unit 415 compares the data of the requested data file for acquisition (instance) with the reacquisition condition information of the reacquisition condition management unit 414. When the data and the reacquisition condition information correspond to each other even for one data, the data acquisition unit 415 does not acquire the data of the data file (instance) requested to be acquired. On the other hand, when the data and the reacquisition condition information do not correspond to each other, the data acquisition unit 415 stores the data of the data file requested to be acquired in the data storage unit of the storage unit 420.

When the data of the data file (instance) requested to be acquired and the re-acquisition condition information correspond to each other, the data acquisition unit 415 may output (return) an error message indicating that acquisition of the data is not permitted to any user (including a user at a providing destination) in the receiving-side server 400 requested to be acquired.

The functions of the receiving-side server 400 have been described above.

As described above, in the data management system 1000, for example, when providing the processing data accompanying the operation of the edge device from the providing-side server 100 to the development environment (e.g., the receiving-side server 400) of the developer, the data provider designates in advance whether it is available or unavailable to acquire the data, so that, even when the provision data is transmitted (i.e., stored) in a decrypted state to the database in the development environment, it is not possible for any user to acquire (download) the processing data via the database operation tool at the providing destination. With such a configuration, it is possible for the data provider to prevent the virtual device data provided to the development environment from being improperly acquired and used. Furthermore, in each application, it is possible to solve the above-described problems without changing any program code related to the use of the database.

The functional blocks included in the providing-side server 100 and the receiving-side server 400 have been described above.

It should be noted that each server included in the data management system 1000 may be implemented by hardware, software, or a combination thereof. Here, “implemented by software” indicates that it is realized by a computer reading and executing a program (application).

For example, the providing-side server 100 and the receiving-side server 400 can be implemented by incorporating a program (application) for implementing the present embodiment into a general server or a virtual server on the cloud.

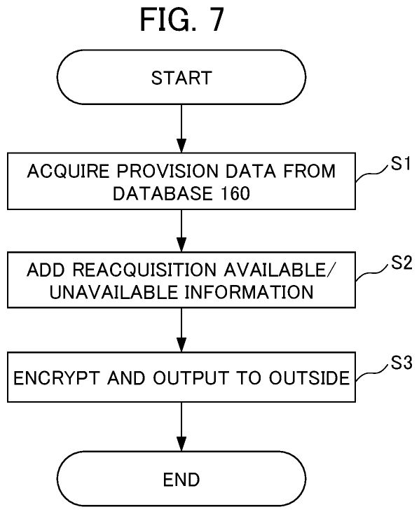

Next, the flow of processing by the providing-side server 100 in the data management system 1000, the flow of processing until the receiving-side server 400 stores the data in the database 460, and the flow of processing of acquiring data in the receiving-side server 400 in the data management system 1000 will be described with reference to FIGS. 7 to 9.

FIG. 7 is a diagram showing an outline of the flow of processing until the providing-side server 100 provides data acquired from its database 160 to the receiving-side server 400. It should be noted that the provision data is encrypted using key data of the public key system.

In Step S1, in response to an instruction from a data provider, the data acquisition unit 111 acquires data to be provided from the database 160.

In Step S2, the reacquisition condition creation unit 112 creates reacquisition available/unavailable information based on the range of the acquired data designated by the data provider and the information as to whether it is available or unavailable to acquire the data in the receiving-side server 400, and adds the reacquisition available/unavailable information to the data acquired in Step S1.

In Step S3, the data output unit 113 encrypts the data file to which the reacquisition available/unavailable information was added in Step S2 with the key data of the public key system (the public key of the receiving side), and outputs the encrypted provision data file to the outside.

Thereafter, the provision data file outputted to the outside is provided to the receiving-side server 400 by a predetermined method.

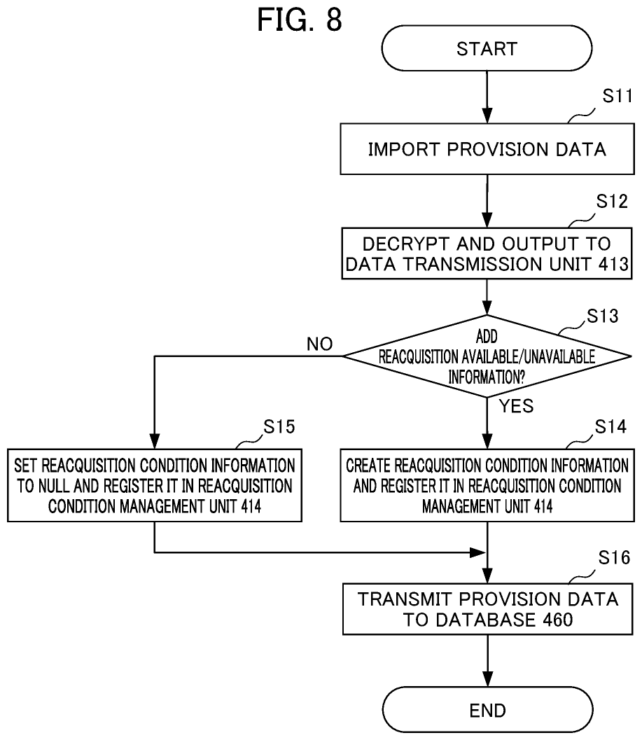

FIG. 8 is a diagram showing an outline of the flow of processing until the receiving-side server 400 receives a provision data file from the providing-side server 100 and stores the file in the database 460 of the receiving-side server 400.

In step S11, the data import unit 412 stores the provision data file provided from the providing-side server 100 in the data storage unit.

In step S12, the data import unit 412 decrypts the data file with the key data (private key on the receiving side) of the public key method and outputs the data file to the data transmission unit 413.

In Step S13, the data transmission unit 413 determines whether or not the reacquisition available/unavailable information other than empty (null) is added to the data file outputted from the data import unit 412. When the reacquisition available/unavailable information other than empty (null) is added (Yes), the processing proceeds to Step S14. When the reacquisition available/unavailable information other than the empty (null) information is not added (No), the processing proceeds to Step S15.

In Step S14, the data transmission unit 413 creates the reacquisition condition information based on the reacquisition available/unavailable information, and registers the reacquisition condition information in the reacquisition condition management unit 414. Thereafter, the processing proceeds to Step S16.

In Step S15, the data transmission unit 413 registers the reacquisition condition information in the reacquisition condition management unit 414 so as to set the reacquisition condition information to null. Thereafter, the processing proceeds to Step S16.

In Step S16, the data transmission unit 413 transmits the provision data to the database 460.

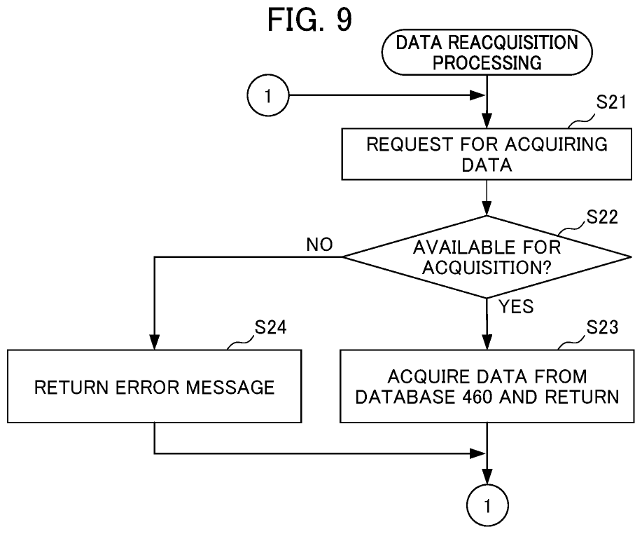

FIG. 9 is a flowchart showing an outline of the flow of the data acquisition processing in the receiving-side server 400.

In Step S21, the data acquisition unit 415 receives a request to acquire data stored in the database 460 from any user (including a user at a providing destination) in the receiving-side server 400.

In Step S22, the data acquisition unit 415 compares the data of the data file (instance) requested to be acquired with the reacquisition condition information of the reacquisition condition management unit 414, and determines whether or not the data is available or unavailable for acquisition. When it is unavailable for acquisition, the processing proceeds to Step S24. When it is not unavailable for acquisition, i.e., the acquisition is available or permitted, the processing proceeds to Step S23.

In Step S23, the data acquisition unit 415 acquires the data requested to be acquired from the database 460, and stores the acquired data in the data storage unit. Thereafter, the processing proceeds to Step S21.

In Step S24, the data acquisition unit 415 outputs (returns) an error message indicating that acquisition of the data is not permitted to any user (including a user at a providing destination) in the receiving-side server 400 that has requested acquisition. Thereafter, the processing proceeds to Step S21.

As described above, by applying the data management system 1000 of the present invention, it is possible to prevent the provided data from leaking to the outside by the provider providing the data to the outside designating in advance whether the data is available or unavailable for acquisition, so that not any user can acquire (download) the data via the database operation tool at the providing destination. With such a configuration, it is possible for the data provider to control the acquisition of data by any user (including the user at the providing destination) in the receiving-side server 400, and thus, it is possible to prevent the provided data from leaking to the outside. In addition, the risk of secondary usage of the provided data can be suppressed.

On the other hand, even on the receiving side receiving the data, for example, in the receiving-side server 400 as the development environment, it is possible to acquire only the data set to empty (null), i.e., set to be able to be available for acquisition, in the reacquisition condition information and, therefore, the security can be automatically improved without changing the program code related to the operation of the server and the use of the database in each application.

Although the above-described embodiments are preferred embodiments of the present invention, the scope of the present invention is not limited to the above-described embodiments, and various modifications can be made without departing from the gist of the present invention.

### Modified Example 1

In the above-described embodiment, the configuration in which the provision data file is directly exchanged between both servers, regardless of whether the provision data file is exchanged via the communication unit, or stored in a storage medium and mailed or handed over from the providing-side server 100 to the receiving-side server 400, is exemplified, but the present invention is not limited thereto. The provision data may be exchanged via the cloud that is set in advance.

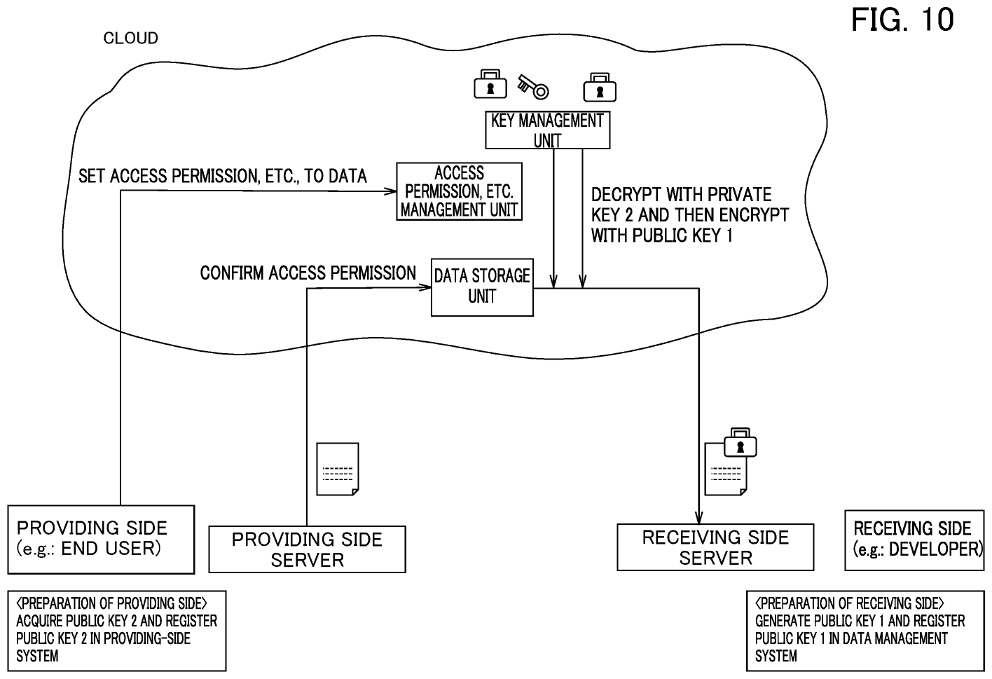

An example of uploading and downloading the provision data via the cloud will be described. FIG. 10 is a schematic diagram showing an example of a mode in which the providing-side server 100 uploads the provision data to the cloud, and the receiving-side server 400 downloads the provision data from the cloud, such that the providing-side server 100 provides the provision data to the receiving-side server 400 via the cloud.

Here, as an example of the encryption method, a public key method is adopted, and an operation of encrypting with a public key or a private key will be described.

First, the cloud is provided with a data management virtual server for managing transmission and reception of data between the providing-side server 100 and the receiving-side server 400. Here, the providing-side server 100 acquires a public key 2 of the data management virtual server, and registers the public key 2 in the providing-side server 100. Furthermore, it is configured such that that the receiving-side server 400 generates a public key 1 of the receiving-side server 400 in advance and registers the public key 1 in the data management virtual server on the cloud.

Thus, the providing-side server 100 (the data output unit 113) encrypts the provision data to be provided to the receiving-side server 400 using the data management virtual server public key 2, and uploads the encrypted data to the data management virtual server. Then, the data management virtual server decrypts the encrypted data using its private key 2 (paired with the public key 2). Then, the data management virtual server encrypts the decrypted provision data using the public key 1 of the receiving-side server 400, and downloads the encrypted data to the receiving-side server 400. In this way, the receiving-side server 400 (the data import unit 412) can decrypt it using its private key 1 (paired with the public key 1).

As described above, when the provision data is uploaded from the providing-side server 100 to the data management virtual server, encryption may be performed using the common key generated by the providing-side server 100. In this case, the providing-side server 100 adds the encrypted common key to the data management virtual server using the public key 2, and performs uploading.

Similarly, when the receiving-side server 400 downloads the provision data from the data management virtual server, the data management virtual server may encrypt the provision data using the common key generated by the data management virtual server. In this case, the data management virtual server uses the public key 1 to download the encrypted common key to the receiving-side server 400.

As described above, the providing-side server 100 can provide the provision data to the receiving-side server 400 via the cloud that is set in advance.

### Modified Example 2

In the above-described embodiment, the providing-side server 100 and the receiving-side server 400 have been described as separate servers, but one server may function as the providing-side server 100 for providing data created in the server to another server, and may function as the receiving-side server 400 for receiving data created in the other server from the other server. That is, one server may have both the functions of the providing-side server 100 and the receiving-side server 400.

### Modified Example 3

The present invention is not limited to a database system that stores virtual device data and virtual device data. As described above, the present invention can be applied to any data and any database system that stores the data. Specifically, since the terms “instance”, “moment”, “data transmission unit” and “transmit data to database” in the database 160 exemplified in the present embodiment correspond to “data files such as tables”, “one record data”, “data registration unit” and “storing data in database” in a normal database system, respectively, the present invention can be read as described above. Therefore, the present invention can be applied to any data and any database system storing the data.

A program such as an application used in the present invention can be stored and supplied to a computer using various types of non-transitory computer-readable media (non-transitory computer readable medium). Non-transitory computer-readable media includes various types of tangible storage media. Examples of non-transitory computer-readable media include magnetic recording media (for example, flexible disks, magnetic tapes, hard disk drives, etc.), magneto-optical recording media (e.g., magneto-optical disks), CD-ROMs (Read Only Memory), CD-Rs, CD-R/Ws, semiconductor memory (for example, mask ROM, PROM (Programmable ROM), EPROM (Erasable PROM), flash ROM, and RAM (random access memory) are used). The program may also be provided to a computer by various types of transitory computer readable media (transitory computer readable medium). Examples of transitory computer-readable media include electrical signals, optical signals, and electromagnetic waves. The transitory computer-readable medium can provide the program to the computer via wired or wireless communication paths such as electric wires and optical fibers.

In view of the above, the present invention can take various embodiments having the following configurations.

(1) The receiving-side server 400 serving as the server of the present disclosure is the data management server including: the control unit 410; the database 460; the reacquisition condition management unit 414 configured to record and manage reacquisition condition information in which information relating to a data file stored in the database 460 and reacquisition available/unavailable information relating to whether the data file is available or unavailable for acquisition are associated with each other; the data transmission unit 413 configured to, based on the reacquisition available/unavailable information added to a data file to be provided from outside of the receiving-side server 400, register the reacquisition condition information of the data file in the reacquisition condition management unit 414 and transmit the data file to the database 460; and the data acquisition unit 415 configured to, when receiving a request for acquiring the data file stored in the database 460, based on the reacquisition condition information managed by the reacquisition condition management unit 414, acquire the data file from the database 460 only when acquisition of the data file is permitted.

With such a configuration, it is possible to prevent the provided data from leaking to the outside by the data provider designating in advance that any user (including a user at a providing destination) in the receiving-side server 400 cannot acquire the data when the data is provided to the outside. It is possible for the data provider to prevent the risk of secondary use of the provided data by any developer.

(2) In the receiving-side server 400 serving as the server according to (1), the reacquisition condition information may include at least identification information of a data file for which it is designated as unavailable for acquisition, and range information of data stored in the data file.

With such a configuration, the data provider can designate whether the provision data is available or unavailable for acquisition based on the range of the data. The data provider can finely conduct control relating to whether the data is available or unavailable for acquisition as necessary.

(3) In the receiving-side server 400 serving as the server according to (2), the data stored in the data file may correspond to at least one of data indicating an action state of an edge device, data indicating a production state of the edge device, data indicating a quality state of a product of the edge device, data indicating an operation state of the edge device, and data indicating an event of the edge device, and the range information of the data may include a period relating to a time stamp generated from the data.

With such a configuration, it is possible to eliminate a hazardous risk (for example, forecasting of the manufacturing capabilities of each machine, the manufacturing capabilities of factories, the sales of companies operating factories, and the like), for example, by analyzing the machine information when the processing data accompanying the operation of the edge device in the manufacturing site is used for an unintended application.

(4) In the receiving-side server 400 serving as the server according to any one of (1) to (3), the reacquisition condition management unit 414 may check the data file stored in the database 460 at a predetermined timing and, when the data file is not present, may delete the reacquisition condition information of the data file.

With such a configuration, it is possible for the receiving-side server 400 to update the reacquisition condition information to the latest state according to the data file stored in the database 460.

(5) In the receiving-side server 400 serving as the server according to any one of (1) to (3), when the range information of the data stored in the data file transmitted by the data transmission unit 413 at least partially overlaps with the range information of the data stored in the database 460, the reacquisition condition management unit 414 updates the reacquisition condition information of the data file.

With such a configuration, it is possible for the receiving-side server 400 to update the reacquisition condition information to the latest state according to the data file stored in the database 460.

(6) The receiving-side server 400 serving as the server according to any one of (1) to (5) may further include the communication unit 430, and a data file provided from outside of the receiving-side server 400 and imported to the receiving-side server 400 may be received via the communication unit 430.

With such a configuration, for example, it is possible to avoid complicated operation due to manual operation.

(7) The data management method according to the present disclosure is a data management method for storing a data file provided from outside in the internal database 460, the method executed by a computer including the control unit 410 and the database 460, the method including the steps of: recording and managing reacquisition condition information in which information relating to a data file stored in the database 460 and reacquisition available/unavailable information relating to whether the data file is available or unavailable for acquisition are associated with each other; based on the reacquisition available/unavailable information added to a data file to be provided from outside of the data management server, registering the reacquisition condition information of the data file and transmitting the data file to the database 460; and when receiving a request for acquiring the data file stored in the database 460, based on the managed reacquisition condition information, acquiring the data file from the database 460 only when acquisition of the data file is permitted.

With such a configuration, it is possible for the data management method to achieve the same advantageous effect as (1).

(8) A data management program according to the present disclosure is the data management program for storing a data file provided from outside in the internal database 460, the program executed by a computer including the control unit 410 and the database 460, the program comprising the steps of: recording and managing reacquisition condition information in which information relating to a data file stored in the database and reacquisition available/unavailable information relating to whether the data file is available or unavailable for acquisition are associated with each other; based on the reacquisition available/unavailable information added to a data file to be provided from outside of the data management server, registering the reacquisition condition information of the data file and transmitting the data file to the database 460; and when receiving a request for acquiring the data file stored in the database 460, based on the managed reacquisition condition information, acquiring the data file from the database 460 only when acquisition of the data file is permitted.

With such a configuration, it is possible for the data management program to achieve the same advantageous effect as (1).

(9) A computer-readable recording medium according to the present disclosure is a computer-readable recording medium storing the data management program according to (8).

With such a configuration, it is possible for the computer-readable recording medium to achieve the same advantageous effect as (1).

(10) A data management system 1000 according to the present disclosure is a data management system including: the receiving-side server 400 serving as a data management server according to (1); and the providing-side server 100 that creates a data file provided from outside to the receiving-side server 400, the providing-side server 100 including the control unit 110, and the database 160, the control unit 110 including the data acquisition unit 111 configured to acquire a data file stored in the database, the reacquisition condition creation unit 112 configured to add to the data file reacquisition available/unavailable information in which whether the data file is available or unavailable for acquisition is designated, and the data output unit 113 configured to output the data file to which the reacquisition available/unavailable information is added by the reacquisition condition creation unit 112 to outside as a provision data file to be provided to the receiving-side server.

With such a configuration, it is possible for the data management system to achieve the same advantageous effect as (1).

### EXPLANATION OF REFERENCE NUMERALS

00 data management system
100 providing-side server
110 control unit
111 data acquisition unit
112 reacquisition condition creation unit
113 data output unit
120 storage unit
130 communication unit
160 database
400 receiving-side server
410 control unit
411 application execution unit.
412 data import unit
413 data transmission unit
414 reacquisition condition management unit
420 storage unit
430 communication unit
460 database

1. A data management server comprising:
a control unit;
a database;
a reacquisition condition management unit configured to record and manage reacquisition condition information in which information relating to a data file stored in the database and reacquisition available/unavailable information relating to whether the data file is available or unavailable for acquisition are associated with each other;
a data transmission unit configured to, based on the reacquisition available/unavailable information added to a data file to be provided from outside of the data management server, register the reacquisition condition information of the data file in the reacquisition condition management unit and transmit the data file to the database; and
a data acquisition unit configured to, when receiving a request for acquiring the data file stored in the database, based on the reacquisition condition information managed by the reacquisition condition management unit, acquire the data file from the database only when acquisition of the data file is permitted.

2. The data management server according to claim 1, wherein the reacquisition condition information includes at least identification information of a data file for which it is designated as unavailable for acquisition, and range information of data stored in the data file.

3. The data management server according to claim 2, the data stored in the data file corresponds to at least one of data indicating an action state of an edge device, data indicating a production state of the edge device, data indicating a quality state of a product of the edge device, data indicating an operation state of the edge device, and data indicating an event of the edge device, and the range information of the data includes a period relating to a time stamp generated from the data.

4. The data management server according to claim 1, wherein the reacquisition condition management unit checks the data file stored in the database at a predetermined timing and, when the data file is not present, deletes the reacquisition condition information of the data file.

5. The data management server according to claim 1, wherein, when the range information of the data stored in the data file transmitted by the data transmission unit at least partially overlaps with the range information of the data stored in the database, the reacquisition condition management unit updates the reacquisition condition information of the data file.

6. The data management server according to claim 1, further comprising a communication unit,
wherein the data file provided from outside of the data management server and imported to the data management server is received via the communication unit.

7. A data management method for storing a data file provided from outside in an internal database,
the method executed by a computer including a control unit and a database, the method comprising the steps of:
recording and managing reacquisition condition information in which information relating to a data file stored in the database and reacquisition available/unavailable information relating to whether the data file is available or unavailable for acquisition are associated with each other;
based on the reacquisition available/unavailable information added to a data file to be provided from outside of the data management server, registering the reacquisition condition information of the data file and transmitting the data file to the database; and
when receiving a request for acquiring the data file stored in the database, based on the managed reacquisition condition information, acquiring the data file from the database only when acquisition of the data file is permitted.

8. A non-transitory computer readable medium encoded with a data management program for storing a data file provided from outside in an internal database,
the program executed by a computer including a control unit and a database, and the program comprising the steps of:
recording and managing reacquisition condition information in which information relating to a data file stored in the database and reacquisition available/unavailable information relating to whether the data file is available or unavailable for acquisition are associated with each other;
based on the reacquisition available/unavailable information added to a data file to be provided from outside of the data management server, registering the reacquisition condition information of the data file and transmitting the data file to the database; and
when receiving a request for acquiring the data file stored in the database, based on the managed reacquisition condition information, acquiring the data file from the database only when acquisition of the data file is permitted.

9. (canceled)

10. A data management system comprising:
a receiving-side server serving as a data management server according to claim 1; and
a providing-side server that creates a data file provided from outside to the receiving-side server,
the providing-side server including
a control unit, and
a database,
the control unit including
a data acquisition unit configured to acquire a data file stored in the database,
a reacquisition condition creation unit configured to add to the data file reacquisition available/unavailable information in which whether the data file is available or unavailable for acquisition is designated, and
a data output unit configured to output the data file to which the reacquisition available/unavailable information is added by the reacquisition condition creation unit to outside as a provision data file to be provided to the receiving-side server.
